(19) United States
(12) Patent Application Publication
(10) Pub. No.: US 2021/0006936 A1
(43) Pub. Date: Jan. 7, 2021

(54) TECHNOLOGY DEPENDENT GEOFENCE

(71) Applicant: HERE Global B.V., Eindhoven (NL)

(72) Inventors: Lauri WIROLA, Tampere (FI); Petri RAUHALA, Tampere (FI); Marko LUOMI, Tampere (FI)

(73) Assignee: HERE Global B.V., Eindhoven (NL)

(21) Appl. No.: 16/982,336

(22) PCT Filed: Mar. 21, 2018
(86) PCT No.: PCT/EP2018/057195

§ 371 Date: Sep. 18, 2020

(51) Int. Cl. H04W 4/021

(52) U.S. Cl. CPC H04W 4/022

(57) ABSTRACT

It is inter-alia disclosed a method performed by an apparatus, said method comprising, for each positioning technique of one or more positioning techniques: determining a representation of a geofence at least partially based on a plurality of parameters, wherein at least one parameter of the plurality of parameters is indicative of an area-of interest and at least one parameter of the plurality of parameters is associated with the respective positioning technique of the one or more positioning techniques.

### FIELD OF THE DISCLOSURE

The invention relates to the field of geofences, and in particular to determining geofences for different positioning techniques.

### BACKGROUND

The number of devices with location capabilities is expected to grow exponentially in the next decade or so. This growth is the result of the Internet-of-Things-era (IoT), in which more and more devices get connected to the Internet. Soon homes, factories, cities and transportation means will be equipped with low-cost sensors that produce real-time information on various characteristics and environment variables. Moreover, the cheaper electronics enables factories and industries to equip assets and supply chains with trackers that provide real-time information on the flow of goods.

The basic ingredient of the IoT story is that the sensors and trackers are location-aware. The location-awareness can be achieved through two means: either the device has its own positioning capabilities (like GNSS or cell/wifi/Bluetooth offline positioning) or the device makes measurements of the radio environment (cell/wifi/Bluetooth) and sends them to the cloud for position determination.

When it comes to small devices that must function autonomously for extended periods of time, power consumption is of special concern. The devices are powered by batteries and, thus, any means to reduce current drain are welcome. As far as location technologies are concerned, there are few ways to reduce power consumption. The greatest power saving results from using the correct technology at the correct time. To exemplify, when low location accuracy is adequate, it is advantageous to use cellular positioning, because it is cheap in terms of energy.

Location is important not only for simple tracking use cases, but also for event notifications. Specifically, when events are tied to geographical constraints, one talks about geofences. A geofence may, for example, be a circular area. When the device enters (or leaves) the defined area, an observer gets notified about the event. While geofences are powerful tools, they may also consume a lot of power. Thus, also in such use cases the correct choice of technology is of essence.

### SUMMARY OF SOME EMBODIMENTS OF THE INVENTION

According to an exemplary embodiment of a first aspect of the invention, a method performed by an apparatus is disclosed, wherein the method comprises, for each positioning technique of one or more positioning techniques: determining a representation of a geofence at least partially based on a plurality of parameters, wherein at least one parameter of the plurality of parameters is indicative of an area-of interest and at least one parameter of the plurality of parameters is associated with the respective positioning technique of the one or more positioning techniques.

This method may for instance be performed and/or controlled by an apparatus, for instance by a mobile device and/or a server.

According to a further exemplary embodiment of the first aspect of the invention, a computer program is disclosed, the computer program when executed by a processor causing an apparatus to perform and/or control the actions of the method according to the exemplary embodiment of the first aspect of the present invention.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary embodiment of the first aspect of the invention, an apparatus (e.g. the first apparatus) is disclosed, configured to perform and/or control or comprising respective means for performing and/or controlling the method according to the exemplary embodiment of the first aspect of the present invention.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit.

In general, the means may comprise for instance one or more processing means or processors.

According to a further exemplary embodiment of the first aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the exemplary embodiment of the first aspect of the present invention.

The above-disclosed apparatus according to the first aspect of the invention may be a module or a component for a device, for example a chip. Alternatively, the disclosed apparatus according to any aspect of the invention may be a device, for instance a gateway device. The disclosed apparatus according to any aspect of the invention may comprise only the disclosed components, for instance means, processor, memory, or may further comprise one or more additional components.

According to an exemplary embodiment of a second aspect of the invention, a method performed by an apparatus is disclosed, wherein the method comprises selecting a representation of a geofence from a plurality of representations of geofences based on a type of a positioning technique.

This method may for instance be performed and/or controlled by an apparatus, for instance a by a mobile device and/or a server.

According to a further exemplary embodiment of the second aspect of the invention, a computer program is disclosed, the computer program when executed by a processor causing an apparatus to perform and/or control the actions of the method according to the exemplary embodiment of the second aspect of the present invention.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary embodiment of the second aspect of the invention, an apparatus (e.g. the first apparatus) is disclosed, configured to perform and/or control or comprising respective means for performing and/or controlling the method according to the exemplary embodiment of the second aspect of the present invention.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary embodiment of the second aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the exemplary embodiment of the second aspect of the present invention.

The above-disclosed apparatus according to second aspect of the invention may be a module or a component for a device, for example a chip. Alternatively, the disclosed apparatus according to any aspect of the invention may be a device, for instance a gateway device. The disclosed apparatus according to any aspect of the invention may comprise only the disclosed components, for instance means, processor, memory, or may further comprise one or more additional components.

In the following, exemplary features and exemplary embodiments of all aspects of the present invention will be described in further detail.

According to an exemplary embodiment of all aspects of the present invention, said one or more positioning techniques are a plurality of different positioning techniques. For instance, the area-of interest of the first aspect of the invention may be the same for each positioning technique of the plurality of positioning techniques, and/or, for instance, said plurality of geofences of the second aspect of the invention may be associated with the same area-of interest.

According to an exemplary embodiment of the first aspect of the present invention, said at least a part of representation of a geofence is indicative of at least one of:
a size of the geofence, and
a shape of the geofence.

According to an exemplary embodiment of the first aspect of the present invention, said determining a representation of a geofence based on a plurality of parameters comprises determining a size and/or a shape of the geofence based on at least one radio coverage area associated with at least one transmitter related to the respective positioning technique.

According to an exemplary embodiment of the first aspect of the present invention, said determining a size and/or a shape of the geofence based on the at least one radio coverage area associated with at least one transmitter related to the respective positioning technique is based on at least one statistical value calculated based on the at least one radio coverage area associated with at least one transmitter related to the respective positioning technique.

According to an exemplary embodiment of the first aspect of the present invention, said at least one statistical value is calculated based on the at least one radio coverage area associated with at least one transmitter related to the respective positioning technique comprises a median or mean size of a radio coverage area of the at least one radio coverage area.

According to an exemplary embodiment of the first aspect of the present invention, said size and/or shape of the geofence determined based on at least one radio coverage area associated with at least one transmitter related to the respective positioning technique is determined based on a database comprising information regarding the at least one transmitter related to the respective positioning technique.

According to an exemplary embodiment of the first aspect of the present invention, the aspect comprises determining a larger size of the geofence in case of a larger radio coverage area compared to determining a smaller size of the geofence in case of a smaller radio coverage area.

According to an exemplary embodiment of the first aspect of the present invention, said size of the geofence is determined such that the determined at least part of a representation of the geofence is not outside an area defined by an aggregation of each radio coverage area of the at least one transmitter related to the respective positioning technique.

According to an exemplary embodiment of the first aspect of the present invention, said size of the geofence is determined such that the determined at least part of a representation of the geofence at least substantially or completely covers each radio coverage area of the at least one transmitter related to the respective positioning technique.

According to an exemplary embodiment of the first aspect of the present invention, the shape of the geofence is determined based on a shape resulting of aggregation of the at least one radio coverage area of the at least one transmitter related to the respective positioning technique.

According to an exemplary embodiment of the first aspect of the present invention, the radio coverage area associated with each of one or more transmitters of the at least one transmitter is at least partially within the area of interest and/or wherein the radio coverage area associated with one or more transmitters of the at least one transmitter is within a predefined distance to the area of interest.

According to an exemplary embodiment of the first aspect of the present invention, the area of interest is at least partially within the radio coverage area associated with each of one or more transmitters of the at least one transmitter and/or wherein the radio coverage area associated with one or more transmitters of the at least one transmitter is within a predefined distance to the area of interest.

According to an exemplary embodiment of all aspects of the present invention, the one or more positioning techniques are one or more positioning techniques of:
a satellite-based positioning technique,
one or more cellular-based positioning techniques,
a WiFi-based positioning technique, in particular based on any IEEE 802.11 standard,
a Bluetooth-based positioning technique, and
an Ultra-Wide Band positioning technique.

According to an exemplary embodiment of all aspects of the present invention, wherein the one or more cellular-based positioning techniques are one or more positioning techniques of:
a GSM-based positioning technique,
NB-IoT based positioning technique,
LoRa based positioning technique,
SigFox based positioning technique,
a 3G or higher based positioning technique, in particular UMTS or LTE or 5G,
LTE Cat M1 based positioning technique, and
any other network based positioning technique

According to an exemplary embodiment of all aspects of the present invention, said area of interest is obtained in response to a user interaction.

The features and example embodiments of the invention described above may equally pertain to the different aspects according to the present invention.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a block diagram of an exemplary embodiment of an apparatus according to a first aspect of the invention;

FIG. 2 is a flow chart illustrating an exemplary embodiment of a method according to the first aspect the invention;

FIGS. 3a-3c show example representations of geofences according to all aspects of the invention;

FIG. 4a show example representations of geofences associated with different positioning techniques according to all aspects of the invention; and

FIG. 4b is a flow chart illustrating another exemplary embodiment of a method according to the first aspect of the invention;

FIGS. 5a-5b show example representations of geofences according to all aspects of the invention;

FIG. 6 is a flow chart illustrating another exemplary embodiment of a method according to the first aspect of the invention;

FIG. 7a is a block diagram of an exemplary embodiment of an apparatus according to a second aspect of the invention;

FIG. 7b is a flow chart illustrating an exemplary embodiment of a method according to the second aspect the invention;

FIG. 8 is a block diagram of an exemplary embodiment of an apparatus according to any aspect the invention;

FIG. 9 is a block diagram of another exemplary embodiment of a server according to any aspect of the invention; and

FIG. 10 is a schematic illustration of examples of tangible and non-transitory storage media according to any aspect of the invention.

### DETAILED DESCRIPTION OF THE FIGURES

The following description serves to deepen the understanding of the present invention and shall be understood to complement and be read together with the description of example embodiments of the invention as provided in the above SUMMARY section of this specification.

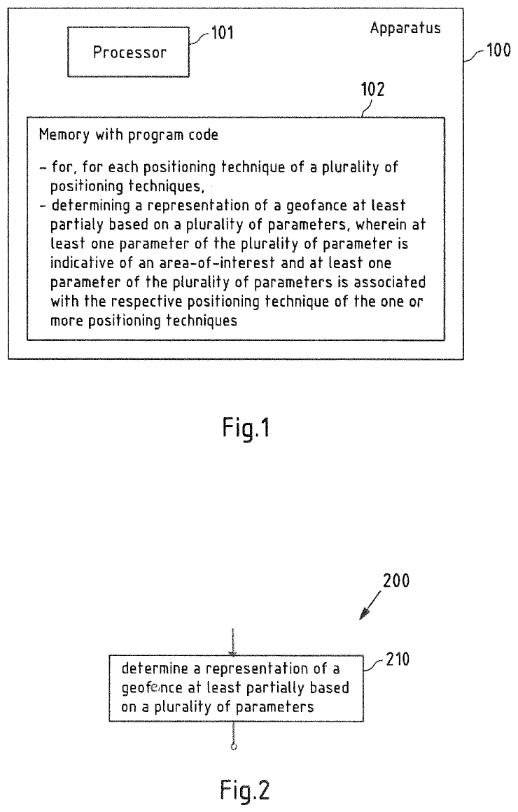

FIG. 1 is a schematic block diagram of an example embodiment of any at least one apparatus according to a first aspect of the invention. Apparatus 100 comprises a processor 101 and, linked to processor 101, a memory 102. Memory 102 stores computer program code for determining a representation of a geofence at least partially (which may include completely) based on a plurality of parameters, wherein at least one parameter of the plurality of parameters is indicative of an area-of interest geofence and at least one parameter of the plurality of parameters is associated with the respective positioning technique of the one or more positioning techniques.

Apparatus 100 could be a server or any other kind of client like a mobile or stationary device. If a plurality of apparatus are used, each apparatus may comprise a processor 101, and linked to processor 101, a memory 102, wherein memory 102 at least partially stores computer program code for determining a representation of a geofence at least partially (which may include completely) based on a plurality of parameters, wherein at least one parameter of the plurality of parameters is indicative of an area-of interest geofence and at least one parameter of the plurality of parameters is associated with the respective positioning technique of the one or more positioning techniques. For instance, said plurality of apparatus may represent servers in a cloud interaction together. Apparatus 100 could equally be a component, like a chip, circuitry on a chip or a plug-in board, for any mobile or stationary device. Optionally, apparatus 100 could comprise various other components, like a data interface configured to enable an exchange of data with separate devices, a user interface like a touchscreen, a further memory, a further processor, etc.

An operation of at least one apparatus will now be described with reference to the flow chart of FIG. 2. The operation is an example embodiment of a method according to the invention. At least one processor 101 (may be one processor 101 or a plurality of processors 101) and the program code stored in at least one memory 102 (may be one memory 102 or a plurality of memories 102) cause at least one apparatus (may be one apparatus or a plurality of apparatuses) to perform the operation when the program code is retrieved from memory 102 and executed by processor 101. The at least one apparatus that is caused to perform the operation can be apparatus 100 or some other apparatus, for example but not necessarily a device comprising apparatus 100.

The at least one apparatus determines a representation of a geofence at least partially (which may include completely) based on a plurality of parameters, wherein at least one parameter of the plurality of parameters is indicative of an area-of interest geofence and at least one parameter of the plurality of parameters is associated with the respective positioning technique of the one or more positioning techniques (action 210). For instance, the at least one parameter of the plurality of parameters associated with the respective positioning technique may be indicative of the respective positioning technique and/or may represent one or more parameters being indicative of a positioning technique specific value, e.g. a size and/or shape of a radio coverage of a transmitter related to the respective positioning technique. For instance, if a plurality of representations of geofences are determined in action 210 for a respective positioning technique, two or more representations of the geofences of the plurality of representations of geofences may differ from each other, e.g. in shape and/or size.

For instance, the one or more positioning technique may be positioning techniques based on wireless communication, i.e., wireless positioning techniques.

A geofence may be considered to be a virtual perimeter for a real-world geographic area. For instance, a geofence may be set around an area-of-interest. As an example, a geofence may be defined by a point and a geometric shape around the point, e.g. a circle or an ellipse around the point. Or, as another example, a geofence may be defined by a polygon, wherein a polygon may be defined by a predefined set of boundaries. Thus, as example, the area of a geofence and/or the shape of a geofence may be defined by one of
a polygon;
a rectangle and/or a square;
a cuboid and/or a cube;
an ellipse and/or a circle; and
an ellipsoid and/or a sphere.

A geofence may be considered to define an area around an area-of-interest. For instance, a geofence could be a check point or a check area on the delivery route of a vehicle, e.g. a truck, and somebody could be interested to know and get a notification when the delivery vehicle visits the check point (or check are), which could for example be one of the delivery locations (areas). Of course, a geofence could be used for any other well-suited area-of-interest, e.g. a school attendance zone or any other zone, wherein a notification may be issued if it is detected that a movable entity, e.g. a vehicle or any mobile device, is within the geofence, i.e., within the boundaries of the geofence. Or, for instance, the area-of-interest could be a factory and the purposed of the geofence may be to notify, when a spare part delivery arrives at the factory.

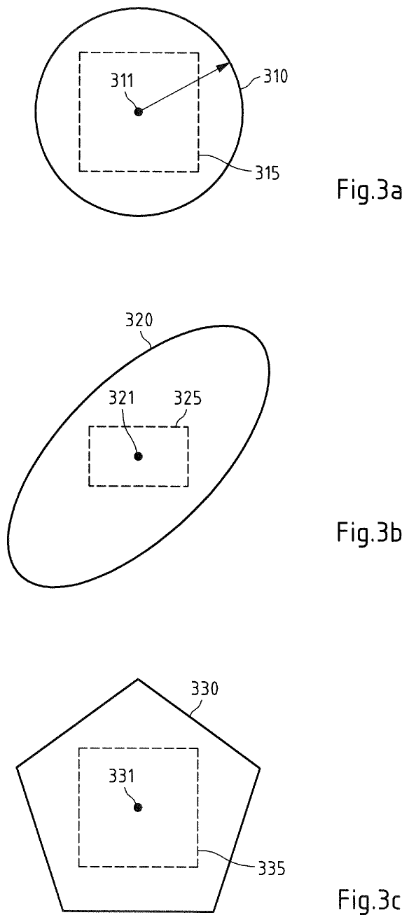

FIGS. 3a to 3c show several non-limiting examples of geofences.

As exemplarily depicted in FIG. 3a, a geofence 310 may be defined by a point 311 and a radius 312 such that an area defined by the geofence is a circle around the point 311 with radius 312, as exemplarily shown in FIG. 3a. The geofence 310 may be around an area-of-interest 315, wherein the shape of the area-of-interest 315 in FIG. 3a is just an example and is therefore not limited to a rectangular shape, but it could take any other well-suited shape, e.g. a polygon, an ellipse and/or a circle, etc.

As exemplarily depicted in FIG. 3b, a geofence may be defined by an ellipse 320, which may be arranged around a point 321 and around an area-of-interest 325.

As exemplarily depicted in FIG. 3c, a geofence may be defined by a polygon 330 set around an area-of-interest 335 and around an optional point 331. For instance, said polygon 330 may be a standard polygon which enables the capture of a complex area in the real-word. In FIG. 3c, point 331 may define the centre of the area defined by geofence 330.

As an example, the area-of-interest 315, 325, 335 may be defined in response to a user interaction with apparatus 100, e.g. via an interface of apparatus 100. The representation of a geofence 310, 320, 330, determined in action 210 for a respective positioning technique may be determined in such a way that the geofence 310, 320, 330, 320, 330 at least partially, in particular completely, surrounds the area-of-interest 315, 325, 335.

For instance, said representation of a geofence may indicative of at least one of (i) a size of the geofence, and (ii) a shape of the geofence, wherein the geofence may be a geofence being around the area-of-interest. Furthermore, and/or, said representation of a geofence may be indicative of a geofence which is around the area-of-interest and thus may be considered to a full representation of the geofence.

As one example, such a size of a geofence may be indicative of the whole size of the geofence 310, 320, 330. Then, for instance, the size of the geofence may be a representative of or correlated to the whole area of the geofence. For instance, if the geofence is defined by a circle, then the radius, or the diameter or the circumference may be a representative of a size of the geofence, or as another example, if the geofence is defined by an ellipse or a polygon, the size being the whole size may be defined by the circumference of the ellipse 320 or the polygon 330 or another suitable representative being correlated with the area defined by the ellipse or the polygon.

As another example, such a size of a geofence may be indicative of an extension (or length) of the geofence in at least one direction (e.g. in exactly one direction). It may be assumed that the extension (or length) of the geofence goes through a predefined point within the area defined by the geofence, wherein this predefined point may represent the centre of the area defined by the geofence.

According to action 210 said at least one parameter of the plurality of parameters is indicative of a type of a respective positioning technique of the one or more positioning techniques. For instance, the respective positioning technique may be a positioning technique applied by or applied for a mobile device.

For instance, a mobile device may be part of may be moved by a movable entity, wherein the movable entity may be a vehicle, e.g. a car or a truck or a motorbike or any other suitable vehicle, or a bike or a person that carries the mobile device and may walk around. The mobile device may be configured to determine its position (e.g. its location) based on a positioning technique. Thus, as an example, the mobile device may comprise means for determining the position of the mobile device, e.g. based on wireless signals received according to a positioning technique. It has to be understood that not all of the one or more positioning techniques must be necessarily be supported by the mobile device. E.g. the mobile device may be configured to support at least one positioning technique of the one or more positioning techniques.

As an example, action 210, i.e., determining of a representation of a geofence at least partially based on a plurality of parameters, wherein at least one parameter of the plurality of parameters is indicative of an area-of interest geofence and at least one parameter of the plurality of parameters is indicative of a type of a respective positioning technique of the one or more positioning techniques, may allow to determine the representation of a geofence to match or to be optimized with respect to type of the respective positioning technique indicated by the least one parameter. For instance, in this way the representation of a geofence may be determined in such a way that it take into account specific characteristics of the respective positioning technique such that the geofence indicated by the determined representation of a geofence may allow trigger of a notification in case a mobile device applies this respective positioning technique and moves into the area (or boundaries) defined by the geofence indicated by the determined representation of a geofence.

For instance, the one or more positioning techniques may be a plurality of positioning techniques, and each positioning technique of the plurality of positioning techniques may be associated with a different wireless communication/transmission system, e.g. satellite based, or cellular based, or WiFi (e.g. based on any 802.11 standard), or Bluetooth based, or ZigBee based, or any other well suited wireless system. Then, as an example, a first positioning technique of the plurality of positioning techniques may be based on a first wireless communication/transmission system having a longer transmission range compared to the transmission range of a second wireless communication/transmission system which is used as basis for a second positioning technique of the plurality of positioning techniques. Then, as an example, if said representation of a geofence is indicative of a size of the geofence, the size of the geofence for the first communication system may be determined in action 210 to have a larger size compared to the size of the geofence associated with the second positioning technique, and/or, vice versa, the size of the geofence for the second communication system may be determined in action 210 to have a smaller size compared to the size of the geofence associated with the first positioning technique, in particular with respect to the same area-of-interest.

Thus, as an example, if a respective type of positioning technique is a cellular based positioning technique, e.g. based on GSM, UMTS, LTE or any other cellular communication system, and if said representation of a geofence is indicative of a size of the geofence, the size of the geofence may be determined in action 210 to have a larger size compared to the size of a geofence of another type of positioning technique which has a shorter range of wireless transmission compared to the cellular communication system of the type of cellular based positioning technique, e.g. a WiFi-based or Bluetooth based positioning technique.

Accordingly, in this way the representation of a geofence determined in action 210 for a respective positioning technique may be tailored and/or optimized with respect to the respective positioning technique based on the at least one parameter being associated with the respective positioning technique.

According to an example, said one or more positioning techniques are a plurality of different positioning techniques such that in action 210 for each positioning technique of the plurality of different positioning techniques, a representation of a geofence based on a plurality of parameters is determined, wherein at least one parameter of the plurality of parameters is indicative of an area-of interest geofence and at least one parameter of the plurality of parameters is indicative of a type of a respective positioning technique. For instance, the area-of interest 315, 325, 335 may be the same for each positioning technique of the plurality of positioning techniques in action 210. Accordingly, for such an area-of interest 315, 325, 335 for each positioning technique of the plurality of positioning techniques a specific representation of a geofence can be determined in action 210, wherein. Thus, as an example, a plurality of representations of a geofence are determined, wherein each representation of a geofence of the plurality of representations of a geofence is associated with a respective different positioning technique and may be associated with the same area-of-interest 315, 325, 335.

As an example, the one or more positioning techniques are one or more positioning techniques of:
a satellite-based positioning technique,
one or more cellular-based positioning techniques,
a WiFi-based positioning technique, in particular based on any IEEE 802.11 standard,
a Bluetooth-based positioning technique, and
an Ultra-Wide Band positioning technique.

Furthermore, for instance, the one or more cellular-based positioning techniques are one or more positioning techniques of: (i) a GSM-based positioning technique, and a 3G or higher based positioning technique, in particular UMTS or LTE or 5G or any cellular system beyond 5G.

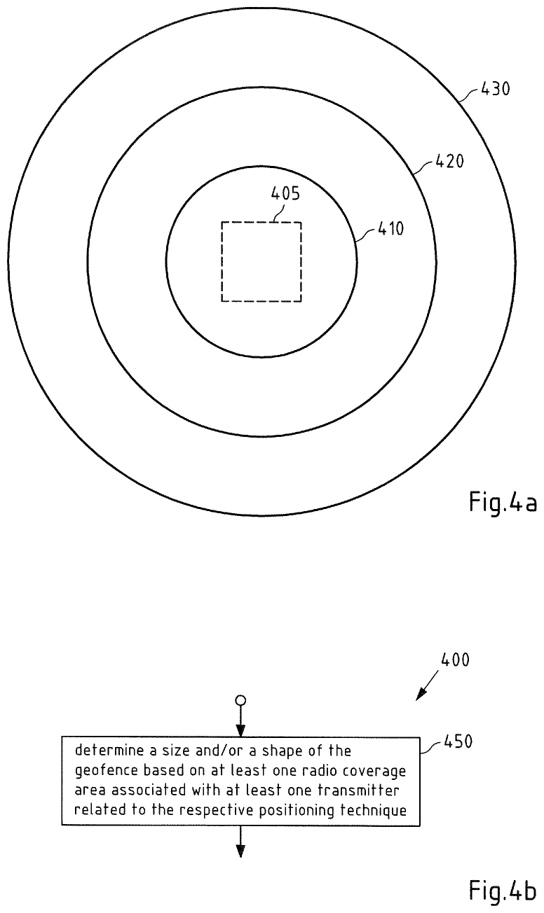

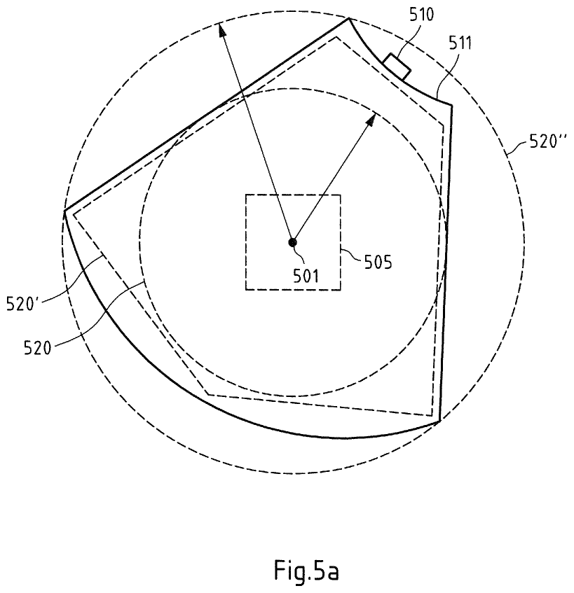

FIG. 4a shows an example for determining three different representations of a geofence 410, 420 430 in action 210 for three different positioning techniques, respectively. For instance, the first positioning technique may be a WiFi-based positioning technique, e.g. based on any standard according to IEEE 802.11, the second positioning technique may be 3G or higher based positioning technique, e.g. UMTS or LTE, and third positioning technique may be a 2G based positioning technique, e.g. based on GSM. Thus, for instance, it may be assumed that the transmission range of GSM transmitter (e.g. GSM base station) is longer than the transmission range of a 3G or higher transmitter (e.g. base station, e.g. denoted as NodeB or other), and it may be assumed that the transmission range of a 3G or higher transmitter (e.g. base station, e.g. denoted as NodeB or other) is longer than the transmission range of a WiFi transmitter (e.g. WiFi access points). As an example, each transmitter associated with a respective positioning technique of the plurality of positioning techniques may be considered to represent a kind of stationary access point AP, e.g. the base station of a cellular communication system or an AP of WiFi communication system or Bluetooth communication system. In the sequel, for instance, each of the above mentioned transmitters (e.g. based station or NodeB in a cellular cellular-based positioning techniques, or AP in any other positioning techniques) may be considered as an access point since even a base station or a NodeB in a cellular communication system provides for a mobile device access to communication system.

Accordingly, in action 210, for the first positioning technique a representation of a geofence 410 is determined based on the area-of-interest 405 and the type of the first positioning technique, which is based on WiFi in this example. Furthermore, in action 210, for the second positioning technique a representation of a geofence 420 is determined based on the area-of-interest 405 and the type of the second positioning technique, which is based on 3G or higher in this example, and in action 210, for the third positioning technique a representation of a geofence 430 is determined based on the area-of-interest 405 and the type of the third positioning technique, which is based on 2G in this example. Each determined representation of a geofence 410, 420, 430 is determined in such a way that is surrounds the areas of interest.

Furthermore, the size of the representation of the geofence 410 associated with the first positioning technique is determined in action 210 to be smaller than the size of the representation of the geofence 420 associated with the second positioning technique, since in this example it can be assumed that the resolution of a position estimation based on the first positioning techniques is higher than the resolution of a position estimation based on the second positioning technique.

Similar, the size of the representation of the geofence 420 associated with the second positioning technique is determined in action 210 to be smaller than the size of the representation of the geofence 430 associated with the third positioning technique, since in this example it may be assumed that the resolution of a position estimation based on the second positioning techniques is higher than the resolution of a position estimation based on the third positioning technique.

Finally, the size of the representation of the geofence 430 associated with the third positioning technique is determined in action 210 to be larger than the size of the representation of the geofence 420 associated with the second positioning technique, since in this example it may be assumed that the resolution of a position estimation based on the third positioning techniques is lower than the resolution of a position estimation based on the second positioning technique.

Thus, for instance, said at least one parameter of the plurality of parameters associated with the respective positioning technique may be indicative of the type of the respective positioning technique and based on the type of the respective positioning technique, a resolution of a position estimation based on the respective positioning technique can be obtained (e.g. based on a knowledge database) which can then be used to determine the representation of the geofence 410, 420, 430, in particular the size of the geofence 410, 420, 430.

Although in FIG. 4a the shape of the geofences 410, 420, 430 is shown as a circle, it has to be understood that any other well-suited shape of geofence 410, 420, 430 may be used, and, for instance, that the shapes of different geofences 410, 420, 430 each being associated with a different positioning technique may differ from each other.

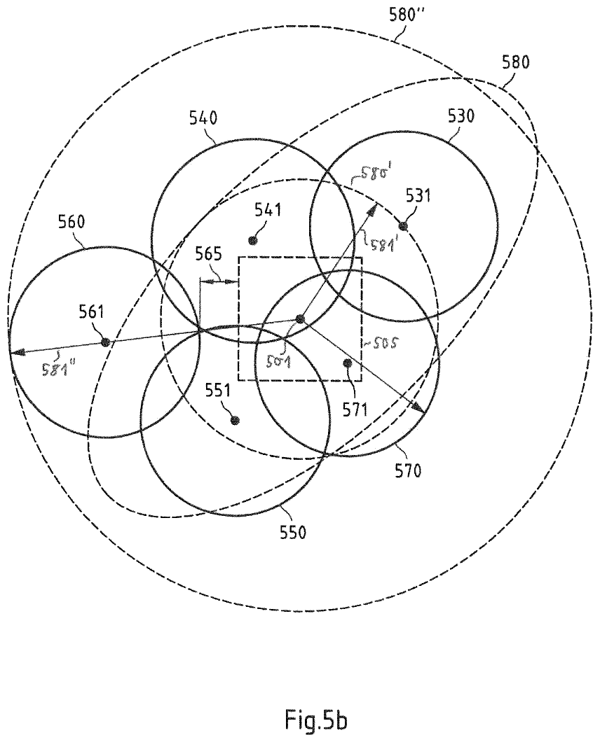

FIG. 5b shows an example embodiment of a method 400 according the present invention. This method 400 may be a part of action 210 of method 200 depicted in FIG. 2.

In action 450 of method 400 a size and/or a shape of the geofence is determined based on at least one radio coverage area associated with at least one transmitter related to the respective positioning technique, wherein, for instance, the determining a representation of a geofence 410, 420, 430 based on a plurality of parameters in action 210 may comprise said determining a size and/or shape of the geofence 410, 420, 430 based on at least one radio coverage area associated with at least one transmitter related to the respective positioning technique of action 450. Thus, for instance, action 450 may be performed for each positioning technique of the one or more positioning techniques mentioned with respect to action 210. For instance, such a transmitter of the at least one transmitter related to the respective positioning technique may represent an access point of the respective positioning technique, e.g. as explained above.

Thus, for instance, said at least one parameter of the plurality of parameters associated with the respective positioning technique may be assumed to indicative of the at least one radio coverage area associated with at least one transmitter related to the respective positioning technique, and, as an example, in particular of size and or shape of a radio coverage areas associated with each transmitter of one or more transmitters of the at least one transmitter related to the respective positioning technique.

As a first example rule of method 400, the radio coverage area associated with each of one or more transmitters of the at least one transmitter is at least partially within the area of interest. Thus, for instance, the respective positioning technique may comprise a plurality of transmitters, wherein each transmitter of the plurality of transmitters is associated with a radio coverage area which may define an area in which the radio signal transmitted by the respective transmitter can be received with a sufficient signal level. E.g., it may be checked whether there are one or more transmitters of the plurality of transmitters of the respective positioning technique, wherein each transmitter of the one or more transmitters of the plurality of transmitters of the respective positioning is associated with a radio coverage area being at least partially (or completely) within the area of interest such that this one or more transmitters can be identified to represent the one or more transmitters of the at least one transmitter being at least partially within the area of interest. Accordingly, one or more transmitters of the plurality of transmitters of the respective positioning technique may be determined, wherein each transmitter of the one or more transmitters of the plurality of transmitters of the respective positioning is associated with a radio coverage area being at least partially (or completely) within the area of interest. For instance, the one or more transmitters of the plurality of transmitters of the respective positioning technique may be determined in such a way that the radio coverage areas associated with all of the one or more transmitters completely cover the area-of-interest.

And/or, as a second example rule of method 400, the area of interest is at least partially within the radio coverage area associated with each of one or more transmitters of the at least one transmitter. E.g., it may be checked whether there are one or more transmitters of the plurality of transmitters of the respective positioning technique, wherein the area of interest at least partially (or completely) within the radio coverage associated with a transmitter of each transmitter of the one or more transmitters of the plurality of transmitters of the respective positioning such that this one or more transmitters can be identified to represent the one or more transmitters of the at least one transmitter, wherein the area of interest is at least partially within the radio coverage area of each transmitter of the one or more transmitters. Accordingly, one or more transmitters of the plurality of transmitters of the respective positioning technique may be determined, wherein the area of interest is at least partially (or completely) within the radio coverage area of each transmitter of the one or more transmitters of the plurality of transmitters of the respective positioning. For instance, the one or more transmitters of the plurality of transmitters of the respective positioning technique may be determined in such a way that the radio coverage areas associated with all of the one or more transmitters completely cover the area-of-interest.

And/or, as a third example rule of method 400, the radio coverage area associated with each of one or more transmitters of the at least one transmitter is within a predefined distance to the area of interest. I.e., in this example the radio coverage area associated with each of one or more transmitters of the at least one transmitter related to the respective positioning technique is not within the area of interest, but the nearest distance between the radio coverage area to the area of interest may be within the predefined distance. This may show the advantage if the radio coverage areas are quite small, e.g. in case of radio coverage areas in an urban areas, compared to radio coverage areas in rural areas, that the determined representation of a geofence is large enough around the area of interest such that detection of a mobile device moving into the geofence may be detected reliable (e.g. for longer location update intervals or higher speeds of the mobile device). In particular, this may hold for cellular based positioning techniques, but it could also hold for other positioning techniques. E.g., it may be checked whether there are one or more transmitters of the plurality of transmitters of the respective positioning technique, wherein each transmitter of the one or more transmitters of the plurality of transmitters of the respective positioning is associated with a radio coverage area which is not within the area of interest, but the nearest distance between the radio coverage area to the area of interest is within the predefined distance. Accordingly, one or more transmitters of the plurality of transmitters of the respective positioning technique may be determined, wherein each transmitter of the one or more transmitters of the plurality of transmitters of the respective positioning is associated with a radio coverage which is not within the area of interest, but the nearest distance between the radio coverage area to the area of interest is within the predefined distance.

It has to be understood that the first example rule, second example rule and third example rule of method 400 can be combined in any way, e.g. the first and second example rules, the first and third example rules, the second and third example rules, and first and second and third example rules, and further, that any of the first, second and third example rules may be taken alone.

Furthermore, as an example, said determining a size and/or a shape of the geofence based on the at least one radio coverage area associated with at least one transmitter related to the respective positioning technique in action 450 may be based on at least one statistical value calculated based on the at least one radio coverage area associated with at least one transmitter related to the respective positioning technique. E.g., at least one statistical value of the at least one statistical value may calculated periodically, i.e., it is updated.

For instance, said at least one statistical value is calculated based on the at least one radio coverage area associated with at least one transmitter related to the respective positioning technique comprises a median or mean size of a radio coverage area of the at least one radio coverage area.

Thus, as an example, for each radio coverage area of the at least one radio coverage area associated with at least one transmitter related to the respective positioning technique a statistical value may be calculated with represents the median or mean size of the radio coverage area. For instance, said median or mean size of the radio coverage area associated with at least one transmitter related to the respective positioning may be calculated periodically, i.e, it can be updated.

Or, as another example, said at least one statistical value calculated based on the at least one radio coverage area associated with at least one transmitter related to the respective positioning technique may represent the median or mean size of a radio coverage area (e.g. denoted as average radio coverage area) calculated based on a plurality of radio coverage areas associated with at least one transmitter related to the respective positioning technique, e.g. across some or all radio coverage areas associated with at least one transmitter related to the respective positioning technique. Then, this statistical value representing the median or mean size of a radio coverage area (e.g. denoted as average radio coverage area) associated with at least one transmitter related to the respective positioning technique may be used everywhere irrespective of the area-of-interest in questions.

For instance, said statistical value representing the median or mean size of a radio coverage area (e.g. denoted as average radio coverage area) associated with at least one transmitter related to the respective positioning may be calculated periodically, i.e., it can be updated.

For instance, as a non-limiting example, FIG. 5a depicts an example radio coverage 515 of a transmitter 510 coupled to an antenna 511 with a specific radiation characteristic, wherein transmitter 510 may be a transmitter of a cellular communication system. In this example, the radio coverage area-of-interest 515 may be associated with a cell 515 of the cellular communication system. The specific radiation characteristic of the transmitter 510 (e.g. together with antenna 511) may define and/or cause a specific shape of the radio coverage area 515 of transmitter 510. It has to be understood that the below explanations, which are presented as an example of method 400, may also hold for other shapes and/or sized of radio coverage area 515.

As an example, the second example rule may be used to determine that transmitter 510 is a transmitter, wherein the area-of interest 505 is at least partially (e.g. in this case completely) within the radio coverage area 515 associated with this transmitter 510.

In this example, it may be assumed that only radio coverage area 515 is used as basis for determining the representation of the geofence in action 450, but it has to be noted that action 450 is not limited to exactly one radio coverage area 515. Then, the size and/or the shape of the geofence 520 determined in action 450 (e.g. also in action 210) is determined based on the radio coverage area 515 of transmitter 510 of the respective positioning technique.

For instance, if the shape of radio coverage area has an at least substantially circular shape the shape of the geofence could be determined to be at least substantially circular shape, or, if the shape of radio coverage area has an at least substantially ellipsoid shape the shape of the geofence could be determined to be at least substantially ellipsoid shape, or, a polygon shape of the geofence 520 may be determined wherein the polygon shape 520 is matched to the shape of the radio coverage area 515 of the transmitter 510 (e.g. as exemplarily shown in FIG. 5a with respect to example geofence 520). And/or, as an example, the size of the geofence may be determined such that the determined geofence 520, 520′ is within the radio coverage area 515 of the transmitter 510 (and e.g. the size of the geofence 520, 520′ may be maximized), or size of the geofence may be determined such that radio coverage area 515 is completely within the determined geofence 520″ (and e.g. the size of the geofence 520″ may be minimized).

Furthermore, as an example, the shape of the geofence 520′, 520″ may be determined to be a circular shape or an ellipsoid shape with a center point 501 within the area-of interest 505 (e.g. irrespective of the shape of the radio coverage area 515 of the transmitter 515), wherein the center point 501 may be in the center 501 of the area-of interest 505. Then, for instance, the size of the circular shaped (or ellipsoid shaped) geofence 520′ may be determined such that the determined geofence 520′ is within the radio coverage area 515 of the transmitter 510 (and e.g. the size of the geofence 520′ is maximized), or size of the circular shaped (or ellipsoid shaped) geofence 520″ may be determined such that radio coverage area 515 is completely within the determined geofence 520″ (and e.g. the size of the geofence 520″ is minimized).

It has to be understood that the size and shape of the radio coverage area 515 in FIG. 5a is just an example and that transmitter 510 and antenna 511 could be replaced by any other well-suited transmitter 510 and/or antenna 515 of the respective positioning technique, wherein, it has further to be understood that the positioning technique is not restricted to a cellular based positioning technique but can be any other well-suited positioning technique.

Furthermore, as another non-limiting example, FIG. 5b depicts an example in which a plurality of transmitters 531, 541, 551, 561, 571 of a respective positioning technique (which may be any positioning technique) are shown, wherein each of the plurality of transmitters 531, 541, 551, 561, 571 is associated with a respective radio coverage area 530, 540, 550, 560, 570, wherein in this example the shape of the radio coverage areas 530, 540, 550, 560, 570 are circular, but one or more of the radio coverage areas of the transmitters 531, 541, 551, 561, 571 may have any other well-suited shape which may depend and the respective 531, 541, 551, 561, 571 and, e.g., an antenna (not shown in FIG. 5b) associated with the transmitter. It has be understood that the below explanations are not restricted to this specific example depicted in FIG. 5b.

For instance, if the first and/or the second example rule is applied, transmitters 531, 541, 551 and 571 could be determined to be one or more transmitters, i.e. the area of interest 505 is at least partially (or completely) within the radio coverage area 530, 540, 550, 570 of each transmitter of the one or more transmitters 531, 541, 551 and 571 of the plurality of transmitters of the respective positioning technique (e.g. according to the second example rule), and/or, the radio coverage area 530, 540, 550, 570 of each transmitter of the one or more transmitters 531, 541, 551 and 571 of the plurality of transmitters is at least partially within the area-of-interest 505 (e.g. according to the first example rule).

In addition, as an example, radio coverage area may also be determined to be one of the one or more radio coverage areas used in action 450 based on the third example rule, since radio coverage area 560 associated with transmitter 561 may within a predefined distance to the area of interest 505. E.g., in this example the nearest distance 565 between the radio coverage area 560 associated with transmitter 561 and the area of interest 505 is within the predefined distance and thus the radio coverage area 560 associated with transmitter 561 may determined to be within a predefined distance to the area of interest 505. Then, for instance, the one or more transmitters used in action 450 may be transmitters 531, 541, 551, 561 and 571.

As a non-limiting example, the shape of the example geofence 580 determined in action 450 may depend on the shape resulting of aggregation (e.g. overlaying) of the radio coverage areas 530, 540, 550, 560, 570 of the one or more transmitters 531, 541, 551, 561 and 571 of the plurality of transmitters of the respective positioning technique, e.g. the shape of the geofence 580 may be determined to at least partially or substantially or completely match to the shape resulting of aggregation (e.g. overlaying) of the radio coverage areas 530, 540, 550, 560, 570 of the one or more transmitters 531, 541, 551, 561 and 571 of the plurality of transmitters of the respective positioning technique. E.g. the aggregation of the radio coverage areas 530, 540, 550, 560, 570 may be assumed to result in at least partially or substantially ellipsoid shape, and thus, as an example, an ellipsoid shape may be determined for geofence 580 in action 450, wherein, for instance, the center point of the ellipsoid shaped geofence 580 may be within the area-of interest 505, wherein the center point 501 of geofence 580 may be in the center 501 of the area-of interest 505. And/or, the size of the geofence 580 determined in action 450 may depend on the shape resulting of aggregation (e.g. overlaying) of the radio coverage areas 530, 540, 550, 560, 570 of the one or more transmitters 531, 541, 551, 561 and 571 of the plurality of transmitters of the respective positioning technique.

As a further non-limiting example, the size of the example geofence 580 determined in action 450 may depend on a size of aggregation (e.g. overlaying) of the radio coverage areas 530, 540, 550, 560, 570 of the one or more transmitters 531, 541, 551, 561 and 571 of the plurality of transmitters of the respective positioning technique.

For instance, the size of the geofence 580′, 580″ may be determined such that the determined geofence 580″ at least substantially (or completely) covers each radio coverage area 530, 540, 550, 560, 570 of the one or more transmitters 531, 541, 551, 561 and 571 of the plurality of transmitters of the respective positioning technique is within the determined geofence 580″ (and e.g. the size of the geofence 580″ may be minimized). Thus, for instance, of the size of the geofence 580′, 580″ may be selected to be a circular shape (however, any other well-suited shape, e.g. ellipsoid or polygon etc., may be selected), then the radius 581″ of the geofence 580″ may be selected to cover even the outer circumference of radio coverage area 560.

For instance, the size of the geofence 580′ may be determined such that the determined that the geofence 580′ is not outside an area defined by the aggregation of each radio coverage area 530, 540, 550, 560, 570 of the one or more transmitters 531, 541, 551, 561 and 571 of the plurality of transmitters of the respective positioning technique and is further still around the area-of-interest, wherein in particular, the size of the geofence 580′ may be maximized but still such that the geofence 580′ is not outside an area defined by the aggregation of each radio coverage area 530, 540, 550, 560, 570 of the one or more transmitters 531, 541, 551, 561 and 571 of the plurality of transmitters of the respective positioning technique. Thus, for instance, of the size of the geofence 580′ may be selected to be a circular shape (however, any other well-suited shape, e.g. ellipsoid or polygon etc., may be selected), then the radius 581′ of the geofence 580′ may be determined to be maximized but to exceed the outer circumference of (e.g. nearest) radio coverage area 570.

As an example, said size and/or shape of the geofence determined based on at least one radio coverage area associated with at least one transmitter related to the respective positioning technique (action 450) may be determined based on a database comprising information regarding the at least one transmitter related to the respective positioning technique. E.g., said information in the database may comprise the at least one statistical value, which may be updated peridiocally or on regular basis. For instance, for a respective positioning technique there may be stored for at least one transmitter the typical shape and/or size of this transmitter, and/or, there may be stored a typical shape and/or size of a transmitter based on a average values of a plurality of transmitters of the respective positioning technique. Accordingly, a kind of knowledge database may be used to collect information regarding typical shapes and sizes of transmitters (e.g. APs) for each positioning technique of the one or more positioning techniques.

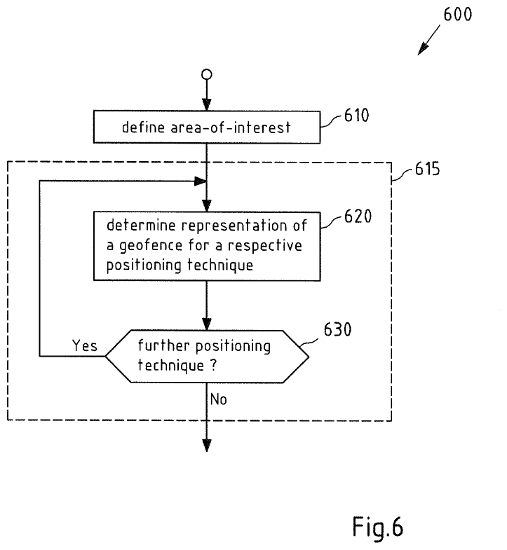

FIG. 6 is a flow chart 600 illustrating another exemplary embodiment of a method according to the invention. For instance, method 600 may be performed by apparatus 100.

Method 600 includes defining an area-of interest in action 610. For instance, this area-of-interest may be that area-of-interest used in action 210 of method 200. As an example, the area-of-interest may be defined in response to a user interaction with apparatus 100, e.g. via an interface of apparatus 100.

Then, in action 620, for a respective positioning technique of the one or more different positioning techniques, a representation of a geofence is determined at least partially based on a plurality of parameters, wherein at least one parameter of the plurality of parameters is indicative of the area-of interest geofence (defined in action 610) and at least one parameter of the plurality of parameters is associated with the respective positioning technique of the one or more positioning techniques, e.g. as described with respect to action 210 and/or to action 450.

In action 630 it may be checked whether there is a further positioning technique, and if yes, method 600 may proceed at action 620 with this further positioning technique as respective positioning technique. In this way, for the area-of-interest defined in action 610, a representation of a geofence may be determined in action 620 for each positioning technique of the one or more positioning techniques.

Apparatus 100, methods 200, 400 and 600 in FIGS. 2, 4b and 6 may be assumed to be associated with a first aspect of the invention.

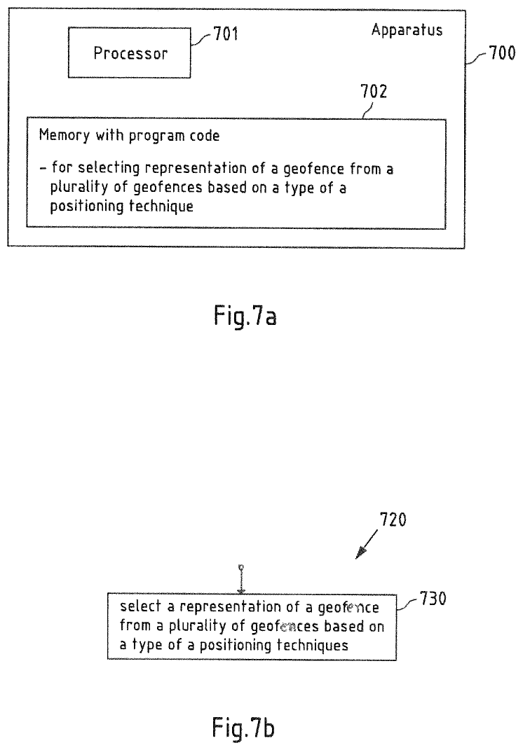

FIG. 7a is a schematic block diagram of an example embodiment of any at least one apparatus according to a second aspect of the invention. Apparatus 700 comprises a processor 701 and, linked to processor 701, a memory 702. Memory 702 stores computer program code for selecting a representation of a geofence from a plurality of representations of a geofence based on a type of a positioning technique. For instance, all explanations presented with respect to the first aspect of the invention may also hold for the second aspect of the invention.

Apparatus 700 could be a server or any other kind of client like a mobile or stationary device. If a plurality of apparatus are used, each apparatus may comprise a processor 701, and linked to processor 701, a memory 702, wherein memory 702 at least partially stores computer program code for selecting a representation of a geofence from a plurality of representations of a geofence based on a type of a positioning technique. For instance, said plurality of apparatus may represent servers in a cloud interaction together. Apparatus 100 could equally be a component, like a chip, circuitry on a chip or a plug-in board, for any mobile or stationary device. Optionally, apparatus 100 could comprise various other components, like a data interface configured to enable an exchange of data with separate devices, a user interface like a touchscreen, a further memory, a further processor, etc.

An operation of at least one apparatus will now be described with reference to the flow chart 720 of FIG. 7b. The operation is an example embodiment of a method according to the second aspect of the invention. At least one processor 701 (may be one processor 701 or a plurality of processors 701) and the program code stored in at least one memory 702 (may be one memory 702 or a plurality of memories 702) cause at least one apparatus (may be one apparatus or a plurality of apparatuses) to perform the operation when the program code is retrieved from memory 702 and executed by processor 701. The at least one apparatus that is caused to perform the operation can be apparatus 700 or some other apparatus, for example but not necessarily a device comprising apparatus 700.

In action 730 of method 720, a representation of a geofence is selected from a plurality of representations of geofences based on a type of a positioning technique. For instance, said plurality of representations geofences may be associated with the same area-of-interest 315, 325, 335, 405, 505, and, as an example, plurality of representations of a geofence may have been determined by means of any of the methods and/or apparatuses of the first aspect of the invention, e.g. based on method 200, 450 and/or 600.

Thus, for instance, each representation of the plurality of representations is associated with a different type of a positioning technique of a plurality of positioning techniques.

Furthermore, as an example, the type of a positioning technique used in action 730 may be determined based on the positioning technique applied by a mobile device. This mobile device may be any mobile device explained with respect to first aspect of the invention. Thus, the representation of the geofence can be selected to match to the positioning techniques applied by the mobile device such that the advantages explained with respect to the first invention may be achieved.

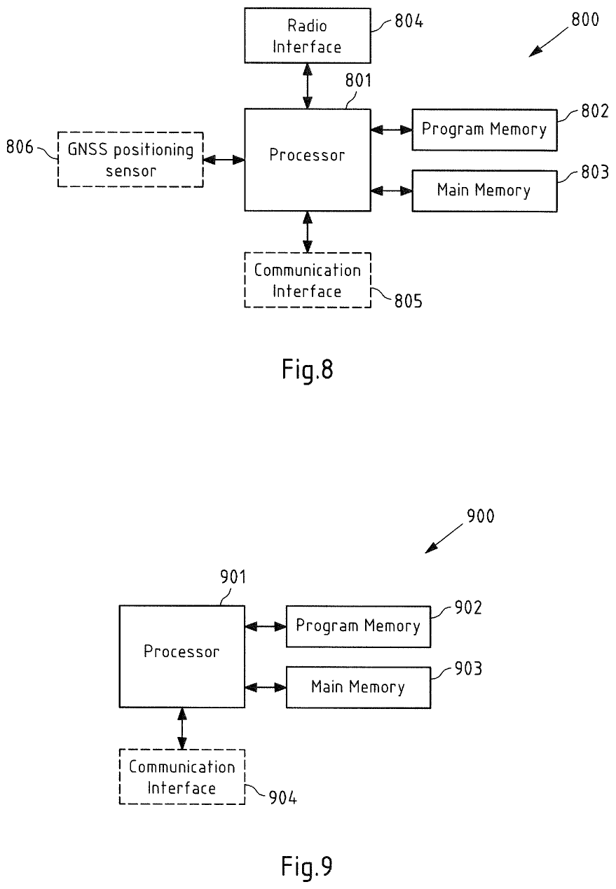

FIG. 8 is a block diagram of an exemplary embodiment of an apparatus in form of a mobile device 800 according to any aspect of the invention. For instance, the mobile device 800 may be any of the previously mentioned apparatuses, e.g. apparatus 100 and 700, and, in particular, apparatus 800 may be a mobile device and/or movable device, e.g. which is used for geofencing. Furthermore, and/or, as an example, mobile device 800 may be configured to perform any of the method 200, 400, 600, 720. For example, mobile device 800 may be one of a smartphone, a tablet computer, a notebook computer, a smart watch and a smart band. For instance, mobile device 800 may be considered to be part or at least carried by a vehicle, e.g. a car or a truck or any other well-suited vehicle.

Mobile device 800 comprises a processor 801. Processor 801 may represent a single processor or two or more processors, which are for instance at least partially coupled, for instance via a bus. Processor 801 executes a program code stored in program memory 802 (for instance program code causing mobile device 800 to perform one or more of the embodiments of a method according to the invention or parts thereof (e.g. the method or parts of the method described below with reference to FIGS. 2, 4b, 6 and 7b), when executed on processor 801), and interfaces with a main memory 803. Program memory 802 may also contain an operating system for processor 801. Some or all of memories 802 and 803 may also be included into processor 801.

One of or both of a main memory and a program memory of a processor (e.g. program memory 802 and main memory 803 and/or program memory 802 and main memory 803 as described below with reference to FIG. 9) could be fixedly connected to the processor (e.g. processor 801 and/or processor 901) or at least partially removable from the processor, for instance in the form of a memory card or stick.

A program memory (e.g. program memory 802 and/or program memory 902 as described below with reference to FIG. 9) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 803 and/or main memory 903 as described below with reference to FIG. 9) may for instance be a volatile memory. It may for instance be a DRAM memory, to give non-limiting example. It may for instance be used as a working memory for processor 801 when executing an operating system and/or programs.

Processor 801 further controls a radio interface 804 configured to receive and/or output data and/or information. For instance, radio interface 804 may be configured to receive radio signals from a radio node. The radio interface 804 is configured to scan for radio signals that are broadcast by radio nodes, e.g. based an WiFi (WLAN) or a Bluetooth or any other radio communications system. Furthermore, the radio interface 804 may be configured for evaluating (e.g. taking measurements on the received radio signals like measuring a received signal strength) and/or extracting data or information from the received radio signals. It is to be understood that any computer program code based processing required for receiving and/or evaluating radio signals may be stored in an own memory of radio interface 804 and executed by an own processor of radio interface 804 or it may be stored for example in memory 803 and executed for example by processor 801. Thus, said radio interface 804 may be configured to support at least one positioning technology of the one or more positioning technologies according to the first and/or second aspect of the invention

For example, the radio interface 804 may at least comprise a BLE and/or Bluetooth radio interface including at least a BLE receiver (RX). The BLE receiver may be a part of a BLE transceiver. It is to be understood that the invention is not limited to BLE or Bluetooth. For example, radio interface 204 may additionally or alternatively comprise a WLAN radio interface including at least a WLAN receiver (RX). The WLAN receiver may also be a part of a WLAN transceiver.

Moreover, for instance, processor 801 may control a further communication interface 805 which is for example configured to communicate according to a cellular communication system like a 2G/3G/4G/5G cellular communication system. Mobile device 800 may use communication interface 805 to communicate with a server, e.g. with server 900 depicted in FIG. 9. Thus, said further communication interface 805 may be configured to support at least one positioning technology of the one or more positioning technologies according to the first and/or second aspect of the invention.

Furthermore, processor 801 may control an optional GNSS positioning sensor 806 (e.g. a GPS sensor or any other GNSS positioning techniques previously mentioned). GNSS positioning sensor may be configured to receive satellite signals of a GNSS system (e.g. GPS satellite signals) and to determine a position of the mobile device (e.g. a current position of the mobile device) at least partially based on satellite signals of the GNSS system that are receivable at this position. Said GNSS positioning sensor may be configured to support one or more positioning technology of the one or more positioning technologies according to the first and/or second aspect of the invention.

The components 802 to 806 of mobile device 800 may for instance be connected with processor 801 by means of one or more serial and/or parallel busses.

It is to be understood that mobile device 800 may comprise various other components. For example, mobile device 800 may optionally comprise a user interface (e.g. a touch-sensitive display, a keyboard, a touchpad, a display, etc.) or one or more inertial sensors (e.g. an accelerometer, a gyroscope, a magnetometer, a barometer, etc.). For instance, said user interface may be configured to receive a user input for defining the area-of-interest (e.g. in or for action 610).

For instance, said mobile device 800 may process the geofence and may track its position in order to provide a notification when the mobile device is within the boundaries of the geofence, wherein geofence may be determined based on action 730 of method 700 and thus may be selected based on the type of the applied positioning technique.

FIG. 9 is a block diagram of an exemplary embodiment of a server 900, which may be a server 900 in a positioning support system.

For instance, said server 900 of the positioning support system may provide and/or process at least one representation of a geofence and may track the position of one or more mobile devices in order to send a notification when a mobile device is within the boundaries of a geofence of the at least one geofence. For instance, said server 900 may be configured to perform any of the methods 200, 400 and 600 in order to determine at least one representations of a geofence for a respective positioning technique of the one or more positioning techniques (e.g. for the same area-of-interest). Furthermore, and/or, for instance, said server 900 may be configured to perform method 720 in order to select a geofence, e.g. based on the type of positioning technique applied by the mobile device. For instance, said notification is provided via a communication system, e.g. via a cellular communication system like a 2G/3G/4G/5G to mobile device such that the notification may be provided to a user of the mobile device via the user interface of mobile device 800.

Server 900 comprises a processor 901. Processor 901 may represent a single processor or two or more processors, which are for instance at least partially coupled, for instance via a bus. Processor 901 executes a program code stored in program memory 902 (for instance program code causing server 900 to perform one or more of the embodiments of a method according to any of the aspects of the invention or parts thereof (e.g. the method or parts of the method described below with reference to FIG. 2, 4b, 6 or 7b, when executed on processor 901), and interfaces with a main memory 903.

Program memory 902 may also comprise an operating system for processor 901. Some or all of memories 902 and 903 may also be included into processor 901.

Moreover, processor 901 controls a communication interface 904 which is for example configured to communicate according to a cellular communication system like a 2G/3G/4G/5G cellular communication system. Server 900 may use communication interface 904 to communicate with mobile devices 610, 800.

The components 302 to 304 of server 900 may for instance be connected with processor 901 by means of one or more serial and/or parallel busses.

It is to be understood that server 900 may comprise various other components. For example, indoor radio positioning server 900 may optionally comprise a user interface (e.g. a touch-sensitive display, a keyboard, a touchpad, a display, etc.). For instance, said user interface may be configured to receive a user input for defining the area-of-interest (e.g. in or for action 610).

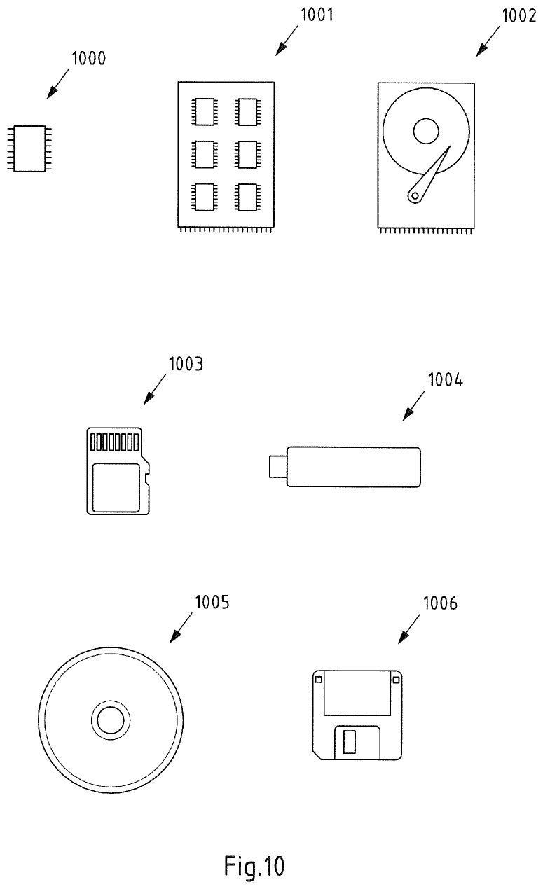

FIG. 10 is a schematic illustration of examples of tangible and non-transitory computer-readable storage media according to the present invention that may for instance be used to implement program memory 102 of FIG. 1 or memory 802 of FIG. 8 or memory 902 of FIG. 9.

To this end, FIG. 10 displays a flash memory 1000, which may for instance be soldered or bonded to a printed circuit board, a solid-state drive 1001 comprising a plurality of memory chips (e.g. Flash memory chips), a magnetic hard drive 1002, a Secure Digital (SD) card 1003, a Universal Serial Bus (USB) memory stick 1004, an optical storage medium 1005 (such as for instance a CD-ROM or DVD) and a magnetic storage medium 1006.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 101 and 701 of FIGS. 1 and 7a, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1. A method performed by an apparatus, said method comprising, for each positioning technique of one or more positioning techniques:

2. The method according to claim 1, wherein said one or more positioning techniques are a plurality of different positioning techniques, and wherein, in particular, the area-of interest is the same for each positioning technique of the plurality of positioning techniques.

3. The method according to claim 1, wherein said at least a part of representation of a geofence is indicative of at least one of:
a size of the geofence, and
a shape of the geofence.

4. The method according to claim 1, wherein said determining a representation of a geofence based on a plurality of parameters comprises determining a size and/or a shape of the geofence based on at least one radio coverage area associated with at least one transmitter related to the respective positioning technique.

5. The method according to claim 4, wherein said determining a size and/or a shape of the geofence based on the at least one radio coverage area associated with at least one transmitter related to the respective positioning technique is based on at least one statistical value calculated based on the at least one radio coverage area associated with at least one transmitter related to the respective positioning technique.

6. The method according to claim 5, wherein said at least one statistical value calculated based on the at least one radio coverage area associated with at least one transmitter related to the respective positioning technique comprises a median or mean size of a radio coverage area of the at least one radio coverage area.

7. The method according to claim 4, wherein said size and/or shape of the geofence determined based on at least one radio coverage area associated with at least one transmitter related to the respective positioning technique is determined based on a database comprising information regarding the at least one transmitter related to the respective positioning technique.

8. The method according to claim 4, comprising determining a larger size of the geofence in case of a larger radio coverage area compared to determining a smaller size of the geofence in case of a smaller radio coverage area.

9. The method according to claim 4, wherein said size of the geofence is determined such that the determined at least part of a representation of the geofence is not outside an area defined by an aggregation of each radio coverage area of the at least one transmitter related to the respective positioning technique.

10. The method according to claim 4, wherein said size of the geofence is determined such that the determined at least part of a representation of the geofence at least substantially or completely covers each radio coverage area of the at least one transmitter related to the respective positioning technique.

11. The method according to claim 4, wherein the shape of the geofence is determined based on a shape resulting of aggregation of the at least one radio coverage area of the at least one transmitter related to the respective positioning technique.

12. The method according to claim 4, wherein the radio coverage area associated with each of one or more transmitters of the at least one transmitter is at least partially within the area of interest and/or wherein the radio coverage area associated with one or more transmitters of the at least one transmitter is within a predefined distance to the area of interest.

13. The method according to claim 4, wherein the area of interest is at least partially within the radio coverage area associated with each of one or more transmitters of the at least one transmitter and/or wherein the radio coverage area associated with one or more transmitters of the at least one transmitter is within a predefined distance to the area of interest.

14. The method according to claim 1, wherein the one or more positioning techniques are one or more positioning techniques of:
a satellite-based positioning technique,
one or more cellular-based positioning techniques,
a WiFi-based positioning technique, in particular based on any IEEE 802.11 standard,
a Bluetooth-based positioning technique, and
an Ultra-Wide Band positioning technique.

15. The method according to claim 14, wherein the one or more cellular-based positioning techniques are one or more positioning techniques of:
a GSM-based positioning technique,
NB-IoT based positioning technique,
LoRa based positioning technique,
SigFox based positioning technique,
a 3G or higher based positioning technique, in particular UMTS or LTE or 5G,
LTE Cat M1 based positioning technique, or
any other network based positioning technique.

16. The method according to claim 1, wherein said area of interest is obtained in response to a user interaction.

17. (canceled)

18. (canceled)

19. An apparatus, said apparatus comprising at least one processor and at least one memory storing computer program code, the at least one memory and the computer program code configured to, with the at least one processor, cause the apparatus to:
determine, for each positioning technique of a plurality of positioning techniques, a representation of a geofence at least partially based on a plurality of parameters, wherein at least one parameter of the plurality of parameters is indicative of an area of interest and at least one parameter of the plurality of parameters is associated with the respective positioning technique of the one or more positioning techniques.

20. A method performed by an apparatus, said method comprising selecting a representation of a geofence from a plurality of representations of geofences based on a type of a positioning technique.

21. The method according to claim 20, wherein each representation of the plurality of representations is associated with a different type of a positioning technique of a plurality of positioning techniques.

22. The method according to claim 20, wherein the type of a positioning technique is determined based on the positioning technique applied by a mobile device.

23. (canceled)

24. (canceled)

25. (canceled)
